(19) United States
(12) Patent Application Publication
(10) Pub. No.: US 2020/0190335 A1
(43) Pub. Date: Jun. 18, 2020

(54) SURFACE TREATMENT METHODS FOR COMPOSITIONS HAVING 1,1-DISUBSTITUTED ALKENE COMPOUNDS

(71) Applicant: Sirrus, Inc., Loveland, OH (US)

(72) Inventors: Anushree S. Deshpande, Cincinnati, OH (US); Aniruddha S. Palsule, Cincinnati, OH (US)

(21) Appl. No.: 16/716,246

(22) Filed: Dec. 16, 2019

Related U.S. Application Data
(60) Provisional application No. 62/780,773, filed on Dec. 17, 2018.

(51) Int. Cl. C09D 4/06

(52) U.S. Cl. CPC C09D 4/06

(57) ABSTRACT

A system and method of forming a coated substrate are provided. A substrate is provided that has a polymeric surface and a lower, initial surface energy. A corona discharge treatment is applied to the polymeric surface. The application of the corona discharge treatment results in a surface energy that is greater than the initial surface energy. A composition having one or more 1,1-disubstituted alkene compounds is deposited directly on the corona treated surface and in direct communication with the surface to provide a coating, eliminating the use of an adhesion promoter.

### CROSS-REFERENCE TO RELATED APPLICATIONS

The present application claims the priority of U.S. provisional patent application Ser. No. 62/780,773, entitled SURFACE TREATMENT METHODS FOR COMPOSITIONS HAVING 1,1-DISUBSTITUTED ALKENE COMPOUNDS, filed Dec. 17, 2018, and hereby incorporates the same application herein by reference in its entirety.

### TECHNICAL FIELD

The present disclosure generally relates to systems, compositions and methods of coating low energy surfaces. The compositions include a 1,1-disubstituted alkene compound and a polymerization initiator.

### BACKGROUND

Polymerizable compositions are useful components in a number of applications and products and can be used, for example, as an adhesive, a coating, a sealant, a molding, a film, or as a composite binder. Obtaining strong adhesion on substrates with low surface energy, such as polyethylene and polypropylene, is difficult however due to the substrates having a non-porous and smooth, slick, surface.

Some methods to obtain improved bonding strength of coatings to polyolefin plastics include chemical etching with strong acids to increase the polarity of the surface of the substrate, the use of a primer or topcoat containing chlorinated polyolefin, and the application of adhesion promoters to the substrate as a tie-coat or a thin layer. Selecting the best approach is difficult since the treatment must increase the surface energy of the substrate and balance the increase in the surface energy of the substrate with the surface tension of the coating. A versatile and flexible surface treatment method is needed to enable the use of a variety of coatings for a variety of applications. In addition, many of the possible surface treatments are multi-step processes and require extra equipment and capital for manufacturing. A method to directly adhere a coating to a plastic substrate would be desirable as is having a process which uses as few steps as possible.

The present disclosure overcomes some of these challenges and provides direct application of coating compositions containing methylene malonates onto corona treated substrates with sufficient adhesion, without the need for an adhesion promotor.

### SUMMARY

According to one aspect a system is provided comprising:

a substrate comprising a polymeric surface having an initial surface energy, wherein the substrate preferably comprises a polymeric material selected from the group consisting of polyolefin plastic and polyamide; wherein the polymeric surface has a second surface energy of about 40 to about 80 dynes/cm after treatment with a corona discharge and wherein the second surface energy is higher that the initial surface energy;

a composition, forming a coating in direct communication with the surface, comprising one or more 1,1-disubstituted alkene compounds, preferably a multifunctional macromer; and

wherein the cross-hatch adhesion of the composition is from about 4 B to 5 B.

According to one aspect, a method of forming a coated substrate is provided, comprising:

providing a substrate comprising a polymeric surface having an initial surface energy, wherein the substrate preferably comprises a polymeric material selected from the group consisting of polyolefin plastic and polyamide;

applying a corona discharge to the polymeric surface at a pressure that is substantially atmospheric and in one aspect the atmosphere may comprise a substantial proportion of oxygen gas and wherein the corona treatment results in a second surface energy that is higher than the initial surface energy, wherein preferably the second surface energy is about 20 to about 80 dynes/cm, preferably from about 40 dynes/cm to about 80 dynes/cm;

depositing a composition directly onto the surface and in direct communication with the surface to provide a coating on the surface; wherein the composition comprises one or more 1,1-disubstituted alkene compounds, preferably a multifunctional macromer; and

exposing the substrate to a temperature from about 20° C. to about 140° C. for about 20 minutes to about 60 minutes to crosslink the 1,1-disubstituted alkene compound.

### DETAILED DESCRIPTION

Definitions

As used herein “essentially free of” means that the system, method or composition contains about 5% or less, about 3% or less, about 1% or less, or about 0.5% or less, of the particular material or compound.

As used herein “direct communication” with the substrate means that the material or coating is, at least partly, in contact with the surface of the substrate, without any intervening layer or material separating the coating from the substrate.

Corona Discharge Treatment

Generally, corona discharge treatments increase the surface energy of plastic films, foils and paper. This increase in surface energy improves wettability and adhesion of inks, coatings and adhesives. As can be appreciated, polymer films generally have chemically inert and non-porous surfaces with low surface tensions causing them to be non-receptive to bonding with substrates, such as printing inks, coatings, and adhesives.

Methods to improve adhesion of coatings to polymeric films have been discovered herein. The methods involve modifying the surface energy of a substrate with corona discharge. As can be appreciated, each film type has an inherent surface energy (dyne level) that can be increased through corona discharge treatment at the time of production. For example, thermoplastic olefins such as polyethylene and polypropylene have a low surface energy of about 28 to about 30 dyne/cm². Thus these types of low surface energy films that are not treated at the time of production will generally not accept printing, coating or lamination very well. As will be described herein, methods of modifying or priming the polymer surfaces are disclosed. The modified or primed surface can be receptive to coatings or can exhibit improved wettability.

In certain aspects, the substrate can be corona treated twice: 1. Pre-treatment performed at the time of production of the substrate during extrusion; and 2. Bump treatment performed in-line prior to converting. As can be appreciated, even if a film is treated during extrusion, the level of treatment may diminish over time. For example, a film that is treated immediately after extrusion can, within a few days or weeks, can lose sufficient surface energy to the point that coating becomes difficult. Since it's difficult to guarantee that a film received will be converted within the required time limit, retreating in-line is often necessary. In certain aspects however, only a single corona treatment can be applied.

Generally, corona discharge equipment includes a high-frequency power generator, a high-voltage transformer, a stationary electrode, and a treater ground roll. For example, suitable corona treating systems can include a power supply that accepts standard 50/60 Hz utility electrical power and converts it into single phase, higher frequency (nominally 10 to 30 kHz) power that is supplied to the treater station. The treater station can apply this power to the surface of the material, through an air gap, via a pair of electrodes at high potential and roll at ground potential which supports the material. In certain aspects, only the side of the substrate facing the high potential electrode will show an increase in surface tension.

As can be appreciated, a corona treating system can be portrayed as a capacitor. Voltage is applied to the top plate which, in the case of a corona treating system, would be the electrode. The dielectric portion of the capacitor can be made up of some type of roll covering, air, and substrate in the corona treater. The final component, or bottom plate, takes the form of an electrically grounded roll. In the corona treating system, the voltage buildup ionizes the air in the air gap, creating a corona, which will increase the surface tension/energy of the substrate passing over the electrically grounded roll. Generally, a single pass can be applied.

In certain embodiments, other surface treatments can alternatively be used. For example, other technologies used for surface treatment can include in-line atmospheric (air) plasma, flame plasma, and chemical plasma systems. Such surface treatments can be used as known in the art.

Generally, corona treatment activates polymer surfaces by generating high energy electrons which can impact the polymer surface. Upon impact, the electrons disassociate molecules on the surface of the polymer surface to create free radicals. These free radicals react with oxygen in the air to increase surface energy and enhance chemical bonding to the polymer surface. In certain embodiments, the free radicals can be oxygen. Other initiating radicals include nitrogen (N), hydroxyl (—OH), and hydrogen (H), which influence the chemical functionalization of these surfaces. Reactive groups, such as carbonyls, hydroxyls, hydroperoxides, aldehydes, ethers, or esters, ultimately may be introduced to the surface. Also the surface of these substrates may also include water-soluble, low-molecular-weight oxidized materials (LMWOM), formed by molecular scission during corona treatment. Surface roughening on corona treated films is caused by the arc discharge impacts at the surface, and the interaction of LMWOM and water in a high humidity environment. The free radicals will form carbonyl groups from the ozone created from the discharge, promoting adhesion. Adhesion occurs at the top atomic layers of the substrate. Appropriately, corona treated surfaces ultimately will raise surface tension/energy on substrates to the preferred level.

Air corona priming can be performed in the presence of ambient atmospheric gases such as nitrogen, oxygen and trace gases at atmospheric pressure. The atmosphere in which the corona treatment is performed can include about 90% to about 99.9% (volume percent) nitrogen gas. Additional additive or trace gases or ingredients can be present, but preferably not in amounts that interfere with the corona discharge or that can result in undesirable properties in the polymer surface being treated. In another aspect the methods described herein can be conducted in the absence of substantial water vapor in the gas surrounding the corona, e.g. less than about 0.1% by volume of water vapor or essentially free of water vapor.

The corona treatment used herein can be characterized by “normalized energy” which is calculated according to the following: Normalized energy=P/wv wherein P is the net power in Watts, w is the corona treatment electrode width in cm, and v is the film velocity in cm/s. Typical units for normalized energy are Joules/cm². The corona discharge may have a normalized energy of from about 0.1 to about 100 or from about 1 to about 20, Joules/cm².

Suitable corona treaters adaptable for use herein can be commercially available from, for example, Sherman Treaters, Ltd. (Thame, UK) and Enercon Industries Corp. (Menomonee Falls, Wis.). An example of a corona system suitable for use herein is provided in the Examples below.

As used herein the term “corona” or “corona discharge” means any of the corona treatment, atmospheric (air) plasma, flame plasma, and chemical plasma systems disclosed herein. Substrates herein may be corona discharge treated substrates. As used herein “corona treated substrates” or “corona discharge treated substrates” are substrates, whereby after treating the substrate with a corona discharge, the surface energy of the substrate is increased so that its surface becomes more impressible to adhesives and coatings.

The substrates herein may be low energy surfaces. As used herein, the term “low energy surface” or “low surface energy” is intended to mean a surface which exhibits low polarity and low critical surface tension of less than about 40 dynes/cm or from about 20 dynes/cm to about 40 dynes/cm. Adhesion problems exist in materials that possess low surface energies. Examples of low energy surfaces include high-density polyethylene, polypropylene, and polyethylene where the surface energy may range anywhere from 29 dyne/cm to 36 dyne/cm or mN/m (mili newton per meter). The adherence of a coating in part may also relate to the difference in polarity between the coating material itself and the surface. Generally, a substrate's surface energy may range at least 5 mN/m (dyne/cm) or from about 5 dyne/cm to about 50 dyne/cm, or about 10 dyne/cm to about 30 dyne/cm, above the surface tension of the coating to be used on the surface.

The substrate herein may comprise polyolefin plastic such as polyethylene (PE). The term “polyethylene” or “PE” is used herein in the broadest sense to include PE of any of a variety of resin grades, density, branching length, copolymer, blend, and catalyst. It may comprise a blend of different grades of polyethylene, including LLDPE, LDPE, VLDPE, HDPE, or MDPE or combinations thereof. Polyolefins may be manufactured using a variety or processes including Ziegler-Natta catalysts, chromium catalysts, metallocene based catalysts, and single site catalysts. The polymers may be homopolymers or copolymers.

The substrate herein may also comprise polyamides, such as nylon. There are many types of nylons commercially available, for example nylon 6, nylon 4/6, nylon 6/6, nylon 6/10, nylon 6/12, nylon 11 and nylon 12. In one aspect the nylon used herein is nylon 66 or nylon 6. Nylon 66 is made of two monomers each containing 6 carbon atoms, hexamethylenediamine and adipic acid. The numerical nomenclature for nylon is derived from the number of carbon atoms in the diamine and dibasic acid monomers used to manufacture it.

Initiator Cured Systems

As will be appreciated, polymerizable systems can be cured on-demand with a polymerization initiator and can be used in many applications where initiator-cured systems that require an external initiator are desirable. Such initiator-cured systems can refer to systems that require an additional component, external to the system, to initiate curing. In contrast, polymerizable systems that can be cured without a polymerization initiator can refer to systems that can undergo polymerization without the introduction, or contact, of any additional components external to the system using instead, for example, anions generated in the polymerizable composition.

Initiator-cured systems are two-part polymerization systems. Two-part polymerization systems generally refer to polymerization systems that require the addition of at least a second component to the system to initiate polymerization. Addition-type polymerization systems are examples of a two-part polymerization system.

According to certain aspects, the compositions comprise suitable compounds such as 1,1-disubstituted alkene compounds having two carbonyl groups bonded to the 1 carbon and a hydrocarbyl group bonded to each of the carbonyl groups (“hereinafter 1,1-disubstituted alkene compounds”). In such 1,1-disubstituted alkene compounds, the hydrocarbyl groups can be bonded to the carbonyl groups directly or through an oxygen atom.

According to certain aspects, suitable hydrocarbyl groups can include at least straight or branched chain alkyl groups, straight or branched chain alkyl alkenyl groups, straight or branched chain alkynyl groups, cycloalkyl groups, alkyl substituted cycloalkyl groups, aryl groups, aralkyl groups, and alkaryl groups. Additionally, suitable hydrocarbyl groups can also contain one or more heteroatoms in the backbone of the hydrocarbyl group.

In certain aspects, a suitable hydrocarbyl group can also, or alternatively, be substituted with a substituent group. Non-limiting examples of substituent groups can include one or more alkyl, halo, alkoxy, alkylthio, hydroxyl, nitro, cyano, azido, carboxy, acyloxy, and sulfonyl groups. In certain aspects, substituent groups can be selected from one or more alkyl, halo, alkoxy, alkylthio, and hydroxyl groups. In certain aspects, substituent groups can be selected from one or more halo, alkyl, and alkoxy groups.

In certain aspects, suitable hydrocarbyl groups can be C₁₋₂₀ hydrocarbyl groups. For example, the hydrocarbyl group can be an alkyl ether having one or more alkyl ether groups or alkylene oxy groups. Suitable alkyl ether groups can include, without limitation, ethoxy, propoxy, and butoxy groups. In certain aspects, suitable hydrocarbyl groups can contain about 1 to about 100 alkylene oxy groups; in certain aspects, about 1 to about 40 alkylene oxy groups; and in certain aspects, about 1 to about 10 alkylene oxy groups. In certain aspects, suitable hydrocarbyl groups can contain one or more heteroatoms in the backbone.

Suitable examples of more specific hydrocarbyl groups can include, in certain aspects, C₁₋₁₅ straight or branched chain alkyl groups, C₁₋₁₅ straight or branched chain alkenyl groups, C₅₋₁₈ cycloalkyl groups, C₆₋₂₄ alkyl substituted cycloalkyl groups, C₄₋₁₈ aryl groups, C₄₋₂₀ aralkyl groups, and C₄₋₂₀ alkaryl groups. In certain aspects, the hydrocarbyl group can more preferably be C₁₋₈ straight or branched chain alkyl groups, C₁₋₂ cycloalkyl groups, C₆₋₁₂ alkyl substituted cycloalkyl groups, C₄₋₁₈ aryl groups, C₄₋₂₀ aralkyl groups, or C₄₋₂₀ alkaryl groups.

As used herein, alkaryl can include an alkyl group bonded to an aryl group. Aralkyl can include an aryl group bonded to an alkyl group. Aralkyl can also include alkylene bridged aryl groups such as diphenyl methyl or propyl groups. As used herein, aryl can include groups containing more than one aromatic ring. Cycloalkyl can include groups containing one or more rings including bridge rings. Alkyl substituted cycloalkyl can include a cycloalkyl group having one or more alkyl groups bonded to the cycloalkyl ring.

In certain aspects, suitable alkyl groups can include methyl, ethyl, propyl, isopropyl, butyl, tertiary butyl, pentyl, hexyl, and ethyl hexyl. Similarly, examples of suitable cycloalkyl groups can include cyclohexyl and fenchyl and examples of suitable alkyl substituted groups can include menthyl and isobornyl.

According to certain aspects, suitable hydrocarbyl groups can include methyl, ethyl, propyl, isopropyl, butyl, tertiary butyl, ethyl pentyl, hexyl, ethyl hexyl, fenchyl, menthyl, and isobornyl groups.

In certain aspects, illustrative examples of 1,1-disubstituted alkene compounds can include methylene malonate compounds, methylene β-ketoester compounds, methylene β-di-ketone compounds, dialkyl disubstituted vinyl compounds, dihaloalkyl disubstituted vinyl compounds and any monofunctional, difunctional, or multifunctional monomers, oligomers, or polymers thereof.

In certain aspects, a 1,1-disubstituted alkene compound included in a suitable composition can be monofunctional, difunctional, or multifunctional. Monofunctional compounds can refer to monomers that have a single addition polymerizable group. Difunctional compounds can refer to monomers, oligomers, resins, or polymers that contain two addition polymerizable groups. Multifunctional compounds can refer to any monomer, oligomer, resin, or polymer that contains three or more addition polymerizable groups. In contrast to monofunctional compounds, difunctional compounds and multifunctional compounds can undergo additional crosslinking, chain-extension, or both, when polymerized.

An illustrative example of a monofunctional 1,1-disubstituted alkene compound is depicted by general formula I:

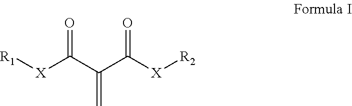

wherein each X can independently be O or a direct bond and R₁ and R₂ can be the same or different and can each represent a hydrocarbyl group.

An illustrative example of a multifunctional monomer having more than one methylene group connected by a multivalent hydrocarbyl group can be depicted by general formula II:

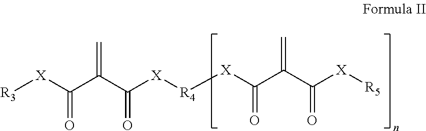

wherein each X can independently be O or a direct bond; R₃ and R₅ can be the same or different and can each represent a hydrocarbyl group; R₄ can be a hydrocarbyl group having n+1 valences; and n is an integer of 1 or greater. In certain aspects, n can be 3 or fewer; and in certain aspects, n can be 2 or fewer, or n can be from 2 to 20 or from 4 to 7.

According to certain aspects, specific examples of suitable polymerizable compositions can include methylene malonate compounds having general formula III:

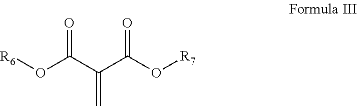

wherein R₆ and R₇ can be the same or different and can each represent a hydrocarbyl group. For example, in certain more specific aspects, suitable methylene malonate compounds can include one or more of diethyl methylene malonate (“DEMM”), dimethyl methylene malonate (“DMMM” or “D3M”), hexyl methyl methylene malonate (“HMMM”), ethylethoxy ethyl methylene malonate (“EEOEMM”), fenchyl methyl methylene malonate (“FMMM”), dibutyl methylene malonate (“DBMM”), di-n-propyl methylene malonate, di-isopropyl methylene malonate, and dibenzyl methylene malonate. Additionally, in certain aspects, certain transesterification reaction products formed from the reaction of methylene malonate compounds with acetates, diacetates, alcohols, diols, and polyols can also be used to form a suitable polymerizable composition.

According to certain aspects, examples of suitable methylene beta ketoesters can be represented by general formula IV:

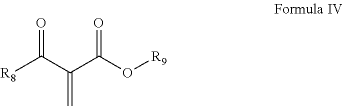

wherein R₈ and R₉ can be the same or different and can each represent a hydrocarbyl group.

According to certain aspects, examples of suitable methylene beta diketones can be represented by general formula V:

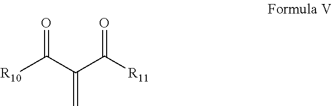

wherein R₁₀ and R₁₁ can be the same or different and can each represent a hydrocarbyl group.

Additional details and methods of making suitable 1,1-disubstituted alkene compounds as well as other suitable compositions are disclosed in U.S. Pat. No. 8,609,885; U.S. Pat. No. 8,884,051; and WO 2014/110388, U.S. Pat. No. 9,567,475, and U.S. Pat. No. 9,745,413, each of which are hereby incorporated by reference.

Generally, polymerization of a composition including a 1,1-disubstituted alkene compound can proceed through living anionic polymerization. As can be appreciated, living anionic polymerization is a process by which nucleophilic species initiate addition reactions with an electrophilic double or triple bond. Living anionic polymerization is not self-terminating and can proceed until quenched or until all of the reactive monomers are consumed.

Initiation of living anionic polymerization can offer a number of benefits. For example, in certain aspects, complete polymerization of compositions having a 1,1-disubstituted alkene compound can occur.

As used herein, complete or full polymerization can mean that polymerization has proceeded until about 25% or less of the composition remains un-polymerized according to certain aspects; about 10% or less of the composition remains un-polymerized according to certain aspects; about 5% or less of the composition remains un-polymerized according to certain aspects; or about 3% or less of the composition remains un-polymerized according to certain aspects. When used as an adhesive, cure time can mean that 75% or more of the composition has been polymerized. Once the cure time has been reached, the polymerized composition can exhibit maximum mechanical strength properties.

Continued polymerization after initiation can allow for the removal, or addition, of the 1,1-disubstituted alkene composition after polymerization has been initiated.

In certain aspects, an additional benefit of living anionic polymerization is the ability to quench polymerization before complete polymerization has occurred. For example, after polymerization has been initiated, a weak acid can be added to the composition to quench any additional polymerization. Quenching can allow for excess composition to be removed or can allow for the formation of weaker polymeric matrixes for targeted and consistent failure modes.

The molecular weight and the molecular weight distribution of a living anionic polymerization can also be influenced. For example, in certain aspects, the molecular weight and molecular weight distribution can be influenced by modifying the method and materials used to initiate the polymerization.

The 1,1-disubstituted alkene composition may comprise polyester macromers and compositions containing them may undergo polymerization when exposed to basic initiators. Polyester macromers are disclosed in U.S. Pat. No. 9,617,377, incorporated herein by reference in its entirely for all purposes. If applied to the surface of a substrate that is basic the polyester macromers will cure via anionic polymerization. Polyester macromers and compositions containing the polyester macromers can undergo cure if contacted with a composition containing basic materials as a polymerization activator. The polymerization activator and methods of delivering the polymerization activator are disclosed in Malofsky U.S. Pat. No. 9,181,365, incorporated herein by reference in its entirety for all purposes. The polymerization activator may be at least one of a base, a base enhancer, a base creator, or a base precursor. In certain aspects, the polymerization activator comprises a basic material selected from a strong base (pH over 9), a moderately strong base (pH from 8-9), or a (mildly basic) weak base (pH from over 7 to 8), or a combination thereof In other aspects, the polymerization activator comprises a basic material selected from an organic material, an inorganic material or an organometallic material, or a combination thereof. The polymerization activator is at least one member selected from: sodium acetate; potassium acetate; acid salts of sodium, potassium, lithium, copper, and cobalt; tetrabutyl ammonium fluoride, chloride, and hydroxide; an amine whether primary, secondary or tertiary; an amide; salts of polymer bound acids; benzoate salts; 2,4-pentanedionate salts; sorbate salts; propionate salts; secondary aliphatic amines; piperidine, piperazine, N-methylpiperazine, dibutylamine, morpholine, diethylamine, pyridine, tri-ethylamine, tripropylamine, tri ethylenediamine, N,N-dimethylpiperazine, butylamine, pentylamine, hexylamine, heptylamine, nonylamine, decylamine; salts of amines with organic monocarboxylic acids; piperidine acetate; metal salt of a lower monocarboxylic acid; copper(II) acetate, cupric acetate monohydrate, potassium acetate, zinc acetate, zinc chloracetate, magnesium chloracetate, magnesium acetate; salts of acid containing polymers; salts of polyacrylic acid copolymers, or pigments having a basic character. In certain aspects, the polymerization activator is encapsulated in a wax, or is provided in inactive engagement with the polymerizable composition by chemical inactivation. In certain aspects the initiator or activator is a tertiary acrylic amine or amine functional acrylic resin such as Setalux 17 1453 available from Nuplex or may be a Lewis acid such as zinc triflate and sulfonic acid derivatives (such as MSA, pTSA). In other aspects the initiator is an amine such as a primary, secondary or tertiary amine. Other amine containing initiator compounds include PEI (polyethylene imine), EMPC (4-(ethylthio)phenyl methylcarbamate).

Additives

In certain aspects, a composition having a 1,1-disubstituted alkene compound can include one or more additives including, for example, one or more dyes, pigments, toughening agents, impact modifiers, rheology modifiers, plasticizing agents, natural or synthetic rubbers, filler agents, reinforcing agents, thickening agents, opacifiers, inhibitors, fluorescence markers, thermal degradation reducers, thermal resistance conferring agents, surfactants, wetting agents, conductive synergists, or stabilizers. For example, thickening agents and plasticizers such as vinyl chloride terpolymer and dimethyl sebacate respectively, can be used to modify the viscosity, elasticity, and robustness of a system. Additives can additionally provide mechanical reinforcement to the polymerized system.

According to certain aspects, stabilizers can be included in compositions having a 1,1-disubstituted alkene compound to increase and improve the shelf life of the composition and to prevent spontaneous polymerization of the system. Generally, one or more anionic polymerization inhibitors such as liquid phase stabilizers (e.g., methanesulfonic acid (“MSA”)), vapor phase stabilizers (e.g., trifluoroacetic acid (“TFA”)), or free radical stabilizers (e.g., 4-methoxyphenol or mono methyl ether of hydroquinone (“MeHQ”)) can be used as a stabilizer package as disclosed in U.S. Pat. No. 8,609,885 and U.S. Pat. No. 8,884,051, each incorporated by reference. Additional free radical polymerization inhibitors are disclosed in U.S. Pat. No. 6,458,956, and are hereby incorporated by reference. Anionic polymerization stabilizers are generally electrophilic compounds that scavenge electrons from the composition or growing polymer chain. The use of anionic polymerization stabilizers can terminate additional polymer chain propagation. Generally, only minimal quantities of a stabilizer are needed and, in certain aspects only about 150 parts-per-million (“ppm”) or less can be included. In certain aspects, a blend of multiple stabilizers can be included such as, for example, a blend of about 10 ppm MSA and 100 ppm MeHQ.

The formed compositions may further contain one or more UV stabilizers which inhibit the degradation of structures containing the polyester macromers. These UV stabilizer materials are disclosed in U.S. Pat. No. 9,567,475, issued Feb. 14, 2017, Palsule et al., which is herein incorporated by reference.

Combinations of certain additives can also have a synergistic improvement on the polymerization time and/or the initiation time. For example, in certain compositions having a 1,1-disubstituted alkene compound and further including MSA and MeHQ as stabilizers, improved cure times can be observed when the stabilizers are included in relatively large ratios. As illustration, a composition including diethyl methylene malonate and about 10 ppm MSA and about 1,000 ppm MeHQ can unexpectedly cure much faster than a composition having diethyl methylene malonate and smaller ratios of MSA and MeHQ. According to certain aspects, the synergistic benefit can occur when the ratio of MSA to MeHQ is about 10:1,000 ppm or more. Similar synergistic benefits can be achieved through the pairing of other acid stabilizers and free radical stabilizers, such as a pairing of maleic acid and 1-acetyl-2-phenylhydrazine or trifluoromethanesulfonic acid and butylated hydroxytoluene. Substitution of MSA and MeHQ with alternative acid and free radical stabilizers can be useful in the tailoring of certain properties (such as surface adhesion) to manufacturing requirements or regulations.

According to certain aspects, chelating agents can also be added to a composition having a 1,1-disubstituted alkene compound. The inclusion of such chelating agents can be useful in a variety of roles and can act, for example, as a metal scavenger, moisture scavenger, synergistic initiation additive, polymerization additive, and/or as a surface compatibility agent. For example, a chelating agent may be useful to remove surface or substrate impurities and can allow for initiation and bonding to a wider range of such surfaces and substrates. Generally, any class of chelating agent can be suitable for inclusion provided the chelating agent does not induce polymerization of the 1,1-disubstituted alkene compound. For example, nonionic chelating agents and oxidizing agents, such as hydroperoxides, can be suitable for inclusion in the polymerizable compositions. Specific examples of suitable chelating agents can include crown ethers, calixarenes, cyclodextrins, and polyethylene glycols. A specific example of an oxidizing agent can include cumene hydroperoxide. A suitable chelating agent, or oxidizing agent, can be added in quantities of about 3% or less, by weight, according to certain aspects; or at quantities of about 1% or less, by weight, according to certain aspects.

Test Methods

Cross-hatch adhesion is determined using ASTM D3359-09, gloss is determined according to ASTM D523-08 at 20° C., 60° C. or 85° C., pencil hardness is determined according to ASTM D3363-00; solvent resistance is determined according to ASTM D5402-93; and acid resistance and base resistance is determined according to GMW 14701.

### EXAMPLES

### Example 1

Amine containing formulations are coated on Nylon-6/6 and on thermoplastic olefin (TPO) and are shown in Table 1. Commercially obtained Nylon 6/6 and TPO substrates are cleaned with acetone and corona discharge treatment is applied to obtain a dyne level of 50 dyne/cm and 60 dyne/cm respectively, prior to clearcoat application. The two-part formulations are mixed and sprayed onto the corona treated substrates. Thereafter the coating is cured according to the conditions in Table 2. Initial coatings performance properties on Nylon -6/6 are tested after 24 hours and are recorded in Table 2. Cure conditions and initial coatings performance properties on corona treated TPO substrates are shown in Table 3. Monomer 1 has the following structure:

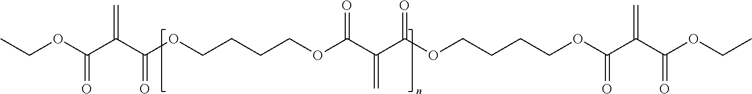

TABLE 1
2-K Formulations Utilizing Acrylic Amine as Initiator

| | Formulation | % Composition |
|---|---|---|
| Substrate | Components | (by wt.) |
| Nylon 6/6 | Monomer 1 | 80.73 |
| (30% Glass-filled) | Setalux 17-1453¹ | 8.97 |
| | PM Acetate² | 10.00 |
| | BYK-333³ | 0.30 |
| Thermoplastic Olefin | Monomer 1 | 71.28 |
| (TPO) (HiFax TYC | Setalux 17-1453 | 7.92 |
| 1235 X Black) | PM Acetate | 20.00 |
| | BYK-333 | 0.30 |
| | Tinuvin 123⁴\grave{ } | 0.50 |

¹An amine functional acrylic resin available from Nuplex.
²Solvent: Propylene glycol monomethyl ether acetate, Reagent plus >99.5% from Sigma Aldrich.
³Leveling agent: Polyether modified polydimethylsiloxane surface additive from BYK by Altana Group.
⁴Tinuvin 123 is bis-(1-octyloxy-2,2,6,6, tetramethyl-4-piperidinyl) sebacate.

TABLE 2
Performance Property Comparison
for Corona Treated and Untreated

| | | Corona |
|---|---|---|
| | Untreated | treated⁵ |
| Cure & Properties | Nylon 6/6 | Nylon 6/6 |
| Cure time and | 25 min | 25 min |
| temperature | at 65° C. | at 65° C. |
| 20/60 Gloss (GU) | 62/80 | 54/72 |
| (ASTM D523-08) | | |
| MEK Resistance | >120 | >120 |
| (double wipes) | | |
| (ASTM 5402-93) | | |
| Pencil Hardness | 4H | 6H |
| (ASTM D3363-00) | | |
| Cross-hatch | 0-3B (coating | 5B (coating |
| adhesion | peeled off the | was intact) |
| (D3359-09) | surface eventually) | |

⁵The corona discharge treatment is applied with a handheld high frequency generator available from Electro-Technic Products, Inc, Model BD-20.

TABLE 3

| | Corona treated |
|---|---|
| Cure & Properties | Thermoplastic Olefin |
| Cure time and temperature | 60 min. at 65° C. |
| 20/60 Gloss (GU) (ASTM D523-08) | (63-71)/(84-85) |
| MEK Resistance (double wipes) | >120 |
| (ASTM 5402-93) | |
| Pencil Hardness (ASTM D3363-00) | H |
| Cross-hatch adhesion (D3359-09) | 5B |

### Example 2

Thermoplastic Polyolefin (TPO) substrates are cleaned with isopropanol and corona treated up to a dyne level of 60 dyne/cm prior to clear coat spray. The corona discharge treatment is applied using a handheld corona treater, Model BD-20, available from Electro-Technic Products, Inc. A non-amine two component formulation (detailed in table 4) is sprayed onto corona treated substrates and cured at 70° C. and 50° C. A commercially available incumbent formulation (also detailed in table 4), having 57.2 wt. % solids, is sprayed onto corona treated substrates and cured at 70° C. and 50° C. Performance properties are summarized in Table 5.

TABLE 4
2K Amine-Free and Incumbent Formulations

| 2K Amine-free | % | Incumbent | % |
|---|---|---|---|
| Formulation | Composition | Formulation | Composition |
| Components | (by weight) | Components | (by Volume) |
| (Part A) | | Part A | |
| Monomer 1 | 41.04% | Imron Elite | 3 parts |
| | | 8840S Clearcoat | |
| | | (from Imron) | |
| (Part B) | | Part B | |
| Joncryl 935 (Acrylic | 41.04% | 194S ™ | 1 part |
| polyol from BASF) | | Activator | |
| Zinc Triflate (as | 0.6% | | |
| solid catalyst, from | | | |
| Sigma Aldrich) | | | |
| Methyl Ethyl Ketone | 5.56% | | |
| (MEK) | | | |
| PM Acetate | 11.11% | | |
| Tinuvin 123 | 0.4% | | |
| BYK-333 | 0.25% | | |

Zinc triflate catalyst was dissolved in methyl ethyl ketone prior to mixing the formulation.

TABLE 5
Performance Properties Comparison

| | Cured at 50° C. | | Cured at 70° C. | |
|---|---|---|---|---|
| | Incumbent | 2K Amine-free | Incumbent | 2K Amine-free |
| | Formulation | Formulation | Formulation | Formulation |
| Tack free time | Slight tack | Tack free | Tack-free | Tack-free |
| | after 1 hour | after 1 hour | after 30 min | after 30 min |
| 20/60 Gloss | 80/90 | 68/89 | 79/91 | 65/89 |
| Cross hatch adhesion | 5B | 5B | 5B | 5B |
| Pencil Hardness | <H | 2 H | <H | 2H |
| MEK resistance | 40 | >120 | 100 | >120 |
| (double wipes) | | | | |
| Mandrel | Flexible | Flexible | Flexible | Failed at |
| Flexibility | | | | lower angles |

The above results in Table 5 demonstrate desirable adhesion of amine-free coating compositions without the use of adhesion promoters, to corona treated thermoplastic olefin with acceptable MEK resistance and flexibility at low temperature cure.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of aspects and examples has been presented for purposes of description. It is not intended to be exhaustive or limiting to the forms described. Numerous modifications are possible in light of the above teachings. Some of those modifications have been discussed and others will be understood by those skilled in the art. The aspects were chosen and described for illustration of various aspects. The scope is, of course, not limited to the examples or aspects set forth herein, but can be employed in any number of applications and equivalent articles by those of ordinary skill in the art. Rather it is hereby intended the scope be defined by the claims appended hereto.

It should be understood that certain aspects, features, structures, or characteristics of the various aspects can be interchanged in whole or in part. Reference to certain aspects means that a particular aspect, feature, structure, or characteristic described in connection with certain aspects can be included in at least one aspect and may be interchanged with certain other aspects. The appearances of the phrase “in certain aspects” in various places in specification are not necessarily all referring to the same aspect, nor are certain aspects necessarily mutually exclusive of other certain aspects. It should also be understood that the steps of the methods set forth herein are not necessarily required to be performed in the orders described, and the order of the steps of such methods should be understood to be merely exemplary. Likewise, additional steps can be included in such methods, and certain steps may be omitted or combined, in methods consistent with certain aspects.

What is claimed is:

1. A method of forming a coated substrate comprising:
providing a substrate comprising a polymeric surface having an initial surface energy;
applying a corona discharge to the polymeric surface at a pressure that is substantially atmospheric and wherein the corona treatment results in a second surface energy that is higher than the initial surface energy, where the second surface energy is about 40 dynes/cm to about 80 dynes/cm;
depositing a composition directly onto the surface and in direct communication with the surface to provide a coating on the surface; wherein the composition comprises one or more 1,1-disubstituted alkene compounds;
exposing the substrate to a temperature from about 20° C. to about 140° C. for 20 minutes to about 60 minutes to crosslink the 1,1-disubstituted alkene compound.

2. The method of claim 1 wherein the 1,1-disubstituted alkene compound is a multifunctional macromer having the formula: 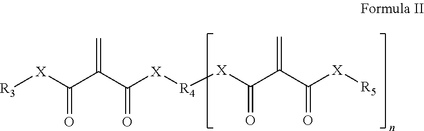
wherein each X can independently be O or a direct bond; R₃ and R₅ can be the same or different and can each represent a hydrocarbyl group; R₄ can be a hydrocarbyl group having n+1 valences; and n is an integer of 1 or greater or n can be from 2 to 20 or from 4 to 7.

3. The method of claim 1 wherein the composition has a cross-hatch adhesion from about 4 B to 5 B.

4. The method of claim 1 wherein the coating on the surface of the substrate further comprises an initiator for polymerization, preferably the initiator comprises a primary, secondary, or tertiary amine or a tertiary acrylic amine polymer initiator or a Lewis acid catalyst.

5. The method of claim 1 wherein the coated substrate is essentially free of an adhesion promotor.

6. The method of claim 1 wherein the substrate comprises a polyolefin or polyamide.

7. The method of claim 1 where the corona discharge has a normalized energy of about 0.1 Joules/cm² to about 100 Joules/cm², of polymeric surface.

8. A system comprising:
a substrate comprising a polymeric surface having an initial surface energy;
wherein the polymeric surface has a second surface energy of about 40 dynes/cm to about 80 dynes/cm after treatment with a corona discharge and wherein the second surface energy is higher that the initial surface energy;
a composition, forming a coating in direct communication with the surface, comprising one or more 1,1-disubstituted alkene compounds;
wherein the cross-hatch adhesion of the composition is from about 4 B to 5 B.

9. The system of claim 8 wherein the 1,1-disubstituted alkene compound is a multifunctional macromer having the formula: 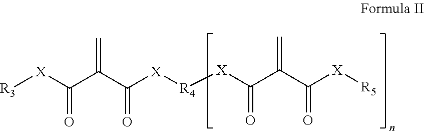
wherein each X can independently be O or a direct bond; R₃ and R₅ can be the same or different and can each represent a hydrocarbyl group; R₄ can be a hydrocarbyl group having n+1 valences; and n is an integer of 1 or greater or n can be from 2 to 20 or from 4 to 7.

10. The system of claim 8 wherein the coating further comprises an initiator for polymerization, preferably the initiator comprises a primary, secondary, or tertiary amine or a tertiary acrylic amine polymer initiator or a Lewis acid catalyst.

11. The system of claim 8 wherein the coating is essentially free of an adhesion promotor.

12. The system of claim 8 wherein the substrate comprises a polyamide or a polyolefin.

13. The system of claim 8 wherein the direct communication of the composition with the surface comprises covalent bonding.
